(19) United States
(12) Patent Application Publication
(10) Pub. No.: US 2018/0267539 A1
(43) Pub. Date: Sep. 20, 2018

(54) Distributive networks of groups of moveable autonomous devices

(71) Applicant: Jeanne Louise Shih, Brossard (CA)

(72) Inventor: Jeanne Louise Shih, Brossard (CA)

(21) Appl. No.: 15/462,747

(22) Filed: Mar. 17, 2017

(51) Int. Cl. G05D 1/00; G06N 7/00; G06N 99/00

(52) U.S. Cl. CPC G05D 1/0088; G06N 99/002; G06N 7/00

(57) ABSTRACT

A method and system for providing a network of devices a way to move or drive in an organized manner where the system is comprised of an artificial intelligence engine powered by blockchain and by at least one quantum computer such that at least one leader device node is elected that sets the main trajectory, path that are followed by the other device nodes in the network. Further to this, blockchain is used to determine a leader node among computer resources such as at least one quantum annealer, at least one quantum computer, at least one supercomputer and any of their respective platform applications and services in order to perform said computations for the network of moving or driving devices.

### CROSS-REFERENCE TO RELATED APPLICATIONS

This application claims the benefits of U.S. provisional patent application No. 62/467208 filed on Mar. 5, 2017 and U.S. provisional patent application No. 62/467818 filed on Mar. 7, 2017.

### TECHNICAL FIELD

The present disclosure generally relates to the field of computer implemented artificial intelligence systems and methods; more particularly to artificial intelligence computing based on quantum annealers and network technologies for the application of autonomous driving devices.

### BACKGROUND

Conventionally, autonomous device networks operate according to single device awareness in a network of devices via sensor technologies such as ultrasonic sensors, radars and lidar or being aware of locally placed obstacles and avoiding them through camera views. Though these are not trivial as technologies in the autonomous device industry, it is worth inspecting how to engineer autonomously driven technologies based on networking methods and systems.

In addition to this, new technologies involving supercomputers, networking and server technologies, quantum computers and quantum annealers are becoming increasingly interesting as commercial solutions in artificial intelligence. Further to this, blockchain is coming into the forefront as a way of managing transactional resources over distributive networks, closing the gap where human trust and risk as well as where risks associated with single device operation may fall short. As of today, negotiating traffic with autonomous vehicles is cited as a problem for the industry by industry leaders.

What is needed is a system and method that uses computational resources in a networked quantum computing environment that drives autonomous devices as a network of devices.

### SUMMARY

A system and method for providing quantum annealing resources to a quantum computing network of autonomous devices is disclosed herein. The method and system described uses at least one quantum annealer, and a traditional supercomputer or a quantum computer with blockchain technologies to drive autonomous devices in different radii and/or vectors of space and in time.

### BRIEF DESCRIPTION OF THE FIGURES

Embodiments of the disclosure will be described by way of example with reference to the accompanying drawings, in which:

FIG. 1 is a block diagram of an exemplary environment for providing quantum annealing resources in a quantum computing artificial intelligence network environment where several moveable user devices nodes are connected to the distributive network.

FIG. 2 is an example of a quantum annealing algorithm used by the quantum annealing processing unit platform applications and/or services connecting to at least one quantum annealer.

FIG. 3 is a flow diagram of a first illustrative embodiment for determining a leader among resource nodes;

FIG. 4 is a flow diagram of a second illustrative embodiment for determining a leader among resource nodes;

FIG. 5 is a flow diagram of a third illustrative embodiment for determining a leader among resource nodes;

FIG. 6 is a flow diagram of a fourth illustrative embodiment for determining a leader among resource nodes;

FIG. 7 is a flow diagram of a first illustrative embodiment for determining a leader among moveable device nodes;

FIG. 8 is a flow diagram of a second illustrative embodiment for determining a leader among moveable device nodes;

FIG. 9 is a flow diagram of a third illustrative embodiment for determining a leader among moveable device nodes;

FIG. 10 is a flow diagram of a fourth illustrative embodiment for determining a leader among moveable device nodes;

FIG. 11 is a diagram of an exemplary environment where several device nodes are being driven.

FIG. 12 is a diagram of an exemplary environment where device nodes are being driven with their spatial surroundings delimited.

FIG. 13 a diagram of an exemplary environment where device nodes are being driven with their spatial surroundings delimited.

FIG. 14 a diagram of an exemplary environment where device nodes on possible collision course are being driven with their spatial surroundings delimited.

### DETAILED DESCRIPTION

Generally stated, the non-limitative illustrative embodiment of the present disclosure provides a system and method for providing quantum annealing resources to a quantum computing network of moveable autonomous devices.

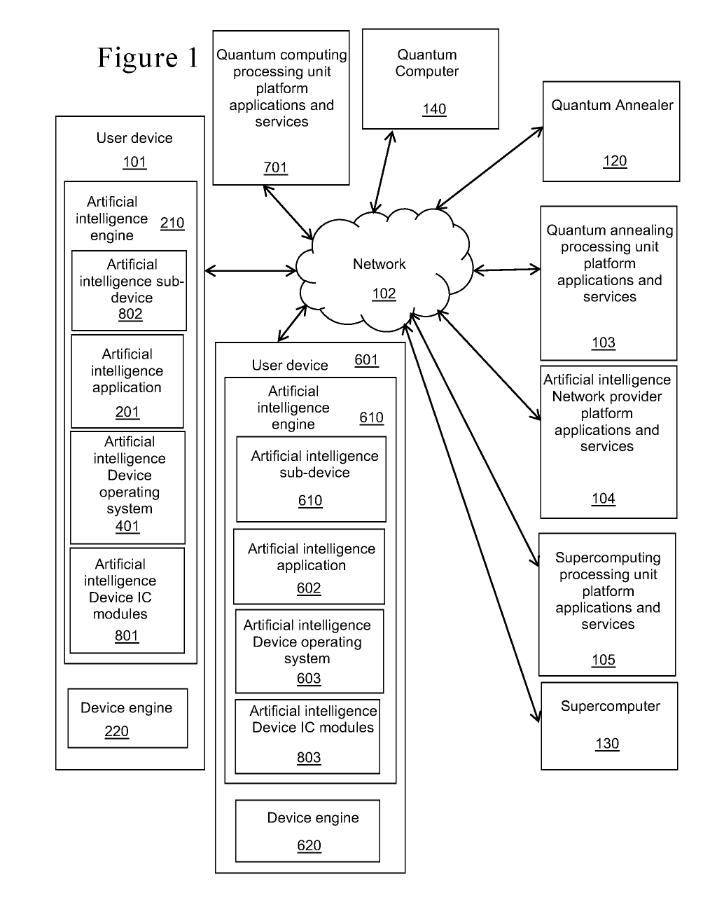

FIG. 1 is a block diagram of an exemplary environment for providing quantum annealing resources in a quantum computing artificial intelligence network where there are several moveable devices 101, 601 connected to the network 102 as is the case in autonomous device networks. User device 101 and 601 may be operating individually and avoiding both non-moving and moving obstacles individually; however these devices 101, 601 are comprised of an artificial intelligence engine 210, 610 for driving in a network of moving devices powered by at least one quantum annealer in addition to a supercomputer or quantum computer implementing blockchain applications and/or services via network 102 and which is tangible as an artificial intelligence application 201, 602 and artificial intelligence device operating system 401, 603 help operate the device engine 220, 620. Artificial intelligence applications 201 and 602 may be identical in this case, even though they may be different. Additionally artificial intelligence device operating system 401 and 603 may be identical or different.

In one embodiment, the core network artificial intelligence may be serviced by the artificial intelligence application 201, 602 and/or the artificial intelligence device operating system 401, 603 in communication via the network 102 with network provider platform applications and/or services (any of which may reside on one or more servers) for driving such autonomous devices as a network of devices. The platform applications and services are in turn, connected to at least one quantum annealer 120 and/or at least one supercomputer 130 and/or quantum computer 140 through network 102 ideally for the purposes of calculating the most optimal trajectory of path to take in consideration of varying state spaces associated to the driving device node, the network of devices, the moving or driving environment. The platform applications and services providing access to quantum computers such as the quantum annealer together provide network trajectory and path optimization computations and functionality to the system. In this case, driving mechanisms may also result from partial interaction from a central command, preferably as an added security measure for an obstacle avoidance engine that may be executed on the artificial intelligence application 201 and 601 and/or operating systems 401, 603. Separate to this, the artificial intelligence engine 210, 610, powered by blockchain, compute a problem set comprised of timings, rates such as speed and accelerations, space differentials, ranges, distances, mapped trajectories and/or paths, estimated time of arrival, as may be obtained via ultrasound, radar, lidar, camera views and maps, information of which may be integrated with visual recognition software such that device nodes may “see” their surroundings. Other data such as the state of the at least one user within the device, the external state or conditions of the device, the internal state or conditions of the device, the music being played within the device or external to the device, etc. may also be data that are computed as part of the calculation for which device is to drive as a momentary leader in a short and/or wide space and length of time. In one embodiment, the leader is the only one among follower nodes to “see” with visual recognition software, whereas the followers are provided with trajectory and paths to follow the leader. The computation is performed by at least one quantum annealer and at least one supercomputer supporting at least one networking technology such as blockchain. The computation may be instantaneous and for immediate use or may be calculated for a length of time to be used after a certain length of time. The latter computation may be a result of analysis of a mapped trajectory and/or path which may be pre-planned or alternatively planned within a short time from actual execution. A quantum annealer with its quantum annealing processing unit platform applications and/or services 103 and/or at least one supercomputer 130 via its supercomputing processing unit platform applications and/or services 105 communicate with the user devices 101 and 601 via network 102. With blockchain consensus algorithms such as Proof of Elapsed time (PofET) and Practical Byzantine Fault Tolerance (PBFT) which are known, these may be used by a node device to send at least one block transaction order to a network of connected autonomous devices whereby these latter receive and act as validator nodes of the distributive ledger network. A leader is elected with the shortest proof of elapsed time for example and this leader node device proceeds to act as the leader of the flock of autonomous devices. A second leader, a third leader, etc. may be determined according to any of the network provider platform applications and services and these may be operating independently through their driving engines comprised of ultrasound, radar, lidar and carmera views and may drive independently according to the data derived from these latter sensor technologies and/or to follow the leader closely or somewhat or further along. New computations are done at intervals in time or new incoming terrain. Since instantaneous and timely, repeated results may be desirable, the use of such supercomputers and fast parallel computing devices such as quantum computers, for example, at least one quantum annealer to compute who is a leader at a specified moment in time within the spatial context and timely context and further, to drive the leader and all of its followers along a specified trajectory and/or path. Weights and coupling coefficients used by at least one quantum computer such as a quantum annealer in its computations may comprise of data related to the state of the device itself such as physical, mechanical, electrical limits, speeds and accelerations and braking data that are allowed with a given device or which may be pushed to a threshold limit or may be limited by economical resource concerns or may be limited to the external conditions of the device or the internal conditions of the device or the state, the status and/or profile of at least one user within a device, owner of the device or the state of the environment the device node is in such as the type of media for example, music being played within or external to the device, the tone of a communication within or external to the device, traffic or congestion data, destination and origin data, incoming new destination data, route data, construction data, etc. Any of these state spaces may be considered as states belonging to a specified number of device nodes as part of a specified distributive network and may be assigned a dimension. State dimensions may change accordingly.

Mathematically, two states are reliably distinguishable if and only if their directions are orthogonal (their inner product is zero). In an embodiment, the computations of the quantum annealer considers only states that are distinguishable from one another. In this case, a dimension metric may be assigned to a blockchain distributive network of device nodes. In another case, a dimension may be assigned or associated with an individual device node. In another embodiment, the device node may be made to “fit” into a distributive network's state space with physical, mechanical, electrical, energetic property changes to adapt to the network of devices, to at least one device node and/or to at least one of its nearby peers and/or its environment being changed.

In one embodiment, device nodes of a same brand or manufacturing may act, operate, behave according to its so-called internal distributive network where specified states are computed by the at least one quantum annealer, whereas other device nodes of other brands or manufacturing may act according to a different distributive network with different specified states computed by the at least one quantum annealer; however in this example, one network may detect the presence of the at least one leader of the other network with its followers and vice versa and avoid one another as simply moving obstacles. In another embodiment, a central command initiates communication between at least two different networks, where a new leader may be elected between the two distributive networks and the network of device follower nodes act, operate and behave accordingly. In another embodiment, it is any of the device nodes from the at least two networks that initiates such communication or merging of network devices into a single distributive network. Ledgers keep track of all transactions and the respective nodes of each ledger network have a copy of an updated ledger, as according to blockchain rules.

A threshold number of leaders (Some being 1^{st}, 2^{nd}, 3^{rd} etc. leaders) may exist in a given distributive network and in one embodiment, all others become followers and by way of example, may move and/or drive at slower pace or be more conservative so to speak in the space and in time. These may also directly follow the trajectories, paths, actions, behaviors of the leader(s) for a specified amount of time. Several consensus algorithms may apply to a specified number of devices rather than just one and therefore leaders for each network may then be part of another distributive network that finds a new leader within a space and time, in which case all other original followers may proceed to follow the newly elected leader. Alternatively in the other embodiment, all nodes participate as part of a single distributive network in a space and in a time.

In this manner, networks of varied devices may transport themselves in a given space and time. These may include any kind of moving device or vehicle.

Reiterating on FIG. 1 is a block diagram of an exemplary environment for providing quantum annealing resources in a quantum computing artificial intelligence network where the autonomous user device 101, 601 operates an artificial intelligence engine 210, 610 comprised of artificial intelligence application 201, 602, an artificial intelligence device operating system 401, 603 and artificial intelligence device integrated circuit modules 801, 803 and may be connected with artificially intelligent sub-devices 802, 610 such as said sensors, radars, lidars, cameras, detectors, etc. The user devices 101 and 601 also comprise of their physical motor engines 220, 620 to move or drive to which the artificial intelligence engine 210, 610 communicate with and/or operate. Artificial intelligence integrated circuit modules 801, 803 may be comprised of customized chips, interface cards, connectors, etc. for autonomous device moving and/or driving and/or operating that are attached to an operating board. These are I/O accessed and operated by the artificial intelligence device operating system 401, 603. The artificial intelligence device operating system 401, 603 may include installed drivers for other artificial intelligence sub-devices 802, 610 and for the driving motor engine 220, 620 connected as part of the core user device 101, 601.

The supercomputing processing unit platform applications and services 105 may comprise of at least one blockchain applications and/or services or other supercomputer related applications and services.

The artificial intelligence network provider platform applications and services 104 may comprise of applications and services to communicate with central command, between user devices 101, 601 and provide applications and services that are related to driving environments, social environments and information receiving environments.

The quantum annealing processing unit platform applications and services comprise applications and services to access and/or operate said quantum annealer.

The quantum computing processing unit platform applications and services comprise applications and services to access and/or operate said quantum computer.

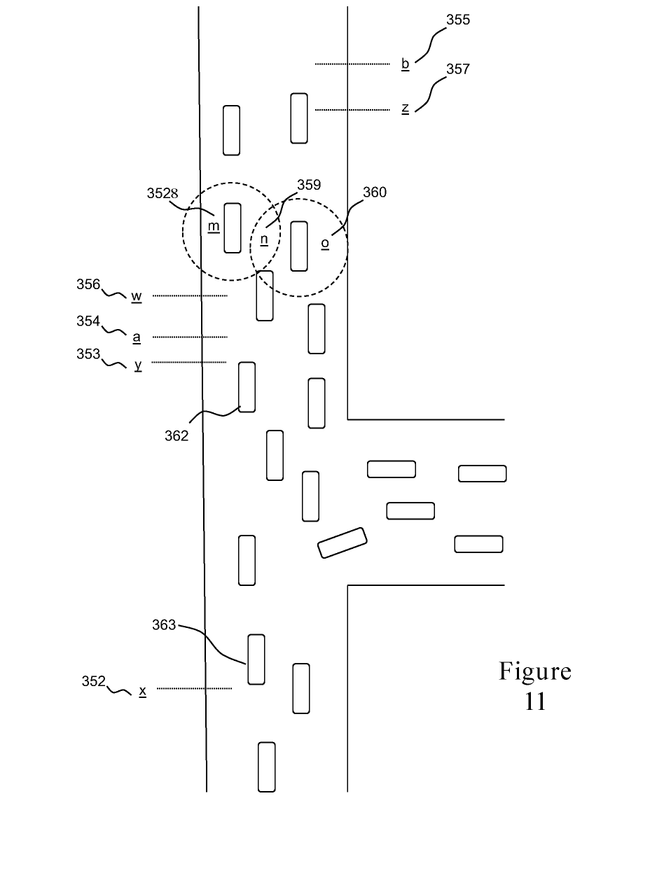

By way of example, referring to FIG. 11, a number of device nodes are identified in a spatial region from point ‘x’ to ‘y’ that may be moving as the device nodes may be moving. The devices at point ‘y’ may be identified as current leaders and the devices at point ‘x’ are identified as last followers (these may be identified as nodes which have the shortest proof of elapsed time (a blockchain consensus algorithm) from their current location to point ‘y’) when first initiated. In other words, when the system is first initiated, a leader may be immediately elected according to a consensus algorithm such as PofET and/or PBFT. The data and profiles of these devices are received by the system and are computed by the quantum computer and/or supercomputer and/or quantum annealer according to the above disclosed method where at least one blockchain consensus algorithm such as Proof of Elapsed Time, is used to determine at least one leader device node. Again referring to FIG. 11, this leader is elected and sets the course for the trajectory, path between points a and b in the spatial region at a given time, for which, in a preferred embodiment, the network of all device nodes are driven with the help of blockchain and the computations from at least one quantum annealer.

To reiterate, in the preferred embodiment, the combination of blockchain and computations from at least one quantum annealer serve to determine at least one leader that drives and leads a network of follower device nodes along an optimized trajectory path. The combination is also used to determine the best resources to use in a network of at least one quantum annealer and at least one quantum computer, at least one supercomputer, at least one network provider and any of their respective platform applications and services.

In one embodiment, points ‘a’ and ‘b’ are delimited by intersections and/or by traffic signage, indicators, path openings and other road delimitations.

In another embodiment, side points ‘c’ and ‘d’ by way of example, may delimit lane and/or structural delimitations and be used in the calculation of ranges and spatial differentials.

In one embodiment, a currency amount may be associated to the leader or second leaders or the followers of the PofET or PBFT distributive networks or any other distributive network.

The spatial points may be comprised of more than two points, may be comprised of a vector field, may be in three spatial dimensions.

In another embodiment, other blockchain consensus algorithms such as proof of work may be operating on the network of device nodes described above and may be assigning a currency such as bitcoin or other cryptocurrencies to the device node (which may not be the computed leader) that finishes the set trajectory or path as computed or according to another goal reached. The currency may be any cryptocurrency associated with the device node or with the at least one user of the device node. The currencies may be assigned according to and/or associated with any of the nodes of the PofET networks or PBFT networks where at least one leader is elected. The currencies may also be assigned to the followers or any of the nodes according to other sets of rules or commercial opportunities in space and in time. The currencies may be assigned according to the said PofET or PBFT algorithms, in which currencies are provided only to the elected leader and a smaller amount to the followers.

In another embodiment, the followers may be categorized according to any of the data mentioned such as follower nodes having similar profiles or similar speeds and may further be introduced into other distributive networks where a new leader among followers may be elected. Referring to FIG. 11, this new leader among the follower nodes may be identified as the leader to set the trajectory, path between points ‘w’ and ‘z’, and since for example, its speed may be low due to a more conservative profile associated with the device node, a set of new rules may be used to determine the trajectory, path and instantaneous driving and/or operating “behavior” between points ‘w’ and ‘z’.

In one embodiment, an engine to provide device node etiquette (behavior or actual protocol) or manners within the blockchain distributive network may apply where the weights and coupling coefficients for state space variables for example are assigned to be computed by a quantum annealer, according to an etiquette profile or rules or regulations or standards or protocols, and are then transferred as physical, mechanical, electrical actions and/or operational behaviors as part of the distributive blockchain network(s) of device nodes. Etiquette may differ according to the actual region the device node may be operating in (for example North American vs. Asian where driving etiquette, though both functional, differ tremendously in form) or may not differ at all, as measured against a common set of etiquette rules required and/or dictated by the requirements and limitations of the devices and environments themselves in their operation and function.

In one embodiment, the behaviors and protocols may be determined before and/or after and/or during at least one leader has been elected in a trajectory, path range.

In another embodiment, the trajectory, path for the next spatial and/or temporal range may be computed before any of the nodes has reached the end of the current trajectory, path and at least one new leader may be elected to pass the current leader in anticipation of (or not) of the new starting spatial and/or temporal point.

In another embodiment, any device node may remove itself from its current distributive network and join another network, whether according to the user of the device node, central command or be removed by the current distributive network of nodes. Alternatively, it may remove itself from its current distributive network and then be driven independently by the user operating the device, should there be one. In one embodiment, this may also occur according to a consensus algorithm such as PBFT where at least one node to be removed from the current network is elected as primary node. Such a node may remove itself to reach a destination and may therefore be the only node in a distributive network guiding the autonomous device node to its said destination. In another embodiment, central command may act as a node in the distributive network, but may also issue a security request to have the device node be removed by other nodes.

In one embodiment, though device nodes may be integrated into a blockchain distributive network or as part of several networks, a device node elected as a follower may be removed from the network after a certain amount of trajectory, path or time has passed and may be driven or moving according to its own single engine, devices, map, trajectory, path, sensor and camera data. Further, after a certain amount of trajectory, path or time on its own, it may again be integrated into at least one distributive network.

In another embodiment, while a network of device nodes are going through a trajectory, path in a time, a layer of machine learning or neural network training may be applied to, for example, a smaller set of device nodes in the distributive network or a single device node in the distributive network. In this case, certain operational actions and behaviors that may not conflict with the overall trajectory, path may be integrated. Such actions and behaviors may follow according to physical elements such as ranges, spatial differentials, separations between device nodes, etc. These may be layered onto the network of device nodes as social, commercial, informational applications and services. Alternatively these may provide a basis for adding human traits to a network of moving and driving devices.

Alternatively, other actions and behaviors may follow according to informational data and/or profiles, said etiquette rules and regulations, of the at least one device node user or the network of device nodes.

In one embodiment, the device nodes of a distributive network may not be in the same physical space and some may not be operating at the same time, or they may be at the same place and time.

In another embodiment, the system as a network of devices monitors for unforeseen events or actions and at least one device node may issue a block transaction order to manage such unforeseen event or action according to a new distributive network and an election of a new leader among validator device nodes for example. In other cases, the event or action may be managed by the same distributive network and the current leader of said network. Alternatively the central command may integrate itself as part the network of reactionary node devices as security measure.

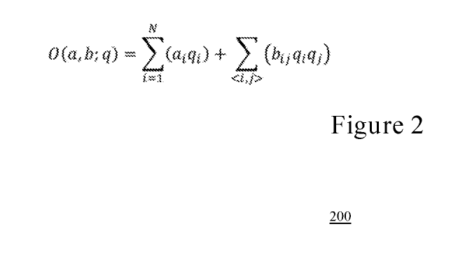

By way of example, referring to FIG. 2, as a preferred embodiment, the adiabatic quantum annealing objective function equation 200 is used by the quantum annealing processing unit platform applications and/or services 103 to compute solutions by modeling a specified problem according to this equation. The quantum annealing processing unit platform applications and/or services 103 encodes the values assigned to and designated as qᵢ and qⱼ (i^{th} and j^{th} qubits) to any of the known items and/or variables in a problem set with their associated weights αᵢ and associated coupler strengths bᵢⱼ as the physical elements operating on one of the quantum annealers such as currents. The quantum annealer performs the computation according to an annealing time and a number of repetition and a so called annealing temperature-time schedule. The annealing time and the number of repetitions may be assigned by the quantum annealer operational schedule manager embodied on the quantum services module (not pictured) provided by the platform applications and/or services 103.

In an embodiment, the annealing time and the number of repetitions may be assigned according to varying specifications provided by at least one quantum annealing application and service. Alternatively, these may be calculated by a supercomputer platform application and service or another quantum computer platform application and service. The specifications may be derived by clusters of data items received by the networking module from other quantum computers 140 via its processing unit platform applications and/or services 701, artificial intelligence network provider platform of applications and/or services 104 and/or other supercomputers 130 via its supercomputing processing unit platform applications and/or services 105, user devices 101, artificial intelligence applications 201, 602 artificial intelligence operating systems 401, 603 and artificial intelligence device IC modules 801, 803, and sub-devices 802, 610 that are connected over network 102.

The equation 200 in FIG. 2 is as such:

$${\sum }_{i = 1}^{N} {a}_{i} {q}_{i} and {\sum }_{< i , j >}^{N} {b}_{ij} {q}_{i} {q}_{j}$$

are summations over a number N qubits considered for a problem being computed which follow the mentioned annealing schedule. Several problems may be scheduled for computation, in sequence or in parallel, in varied order.

Blockchain, in addition to determining moving device leaders and followers, determines resource leaders and followers. In the preferred embodiment, a network of resource nodes, which may be any of the entities described such as user device 101, quantum computer 140, supercomputer 130, quantum annealer 120 may participate in a distributive blockchain network where quantum annealing resources are managed. The quantum annealing platform application and services 103 is tasked with assigning qubits qᵢ and qⱼ to any known item and/or variable in a problem set. Further to this, the associated weights and coupling coefficients may be determined by any of the platform application and services 103, 105, 701 (any of which may reside on one or more servers) associated with at least one quantum annealer 120, supercomputer 130, quantum computer 140 respectively and providing the values of aᵢ and/or b_{i,j} as part of state space variables. At least one consensus algorithm such as PofET is implemented in which participating resource nodes are considered as validator nodes. Chaincode based on blockchain logic may be provided by a supercomputing processing unit platform applications and services 105. This is to assign to several networked resource nodes as validator nodes which place an order for the request of at least one transaction block to be broadcast over the distributive network to compute the problem set according to the equation 200 assigned to the specified problem with the associated weights and coupling coefficients as part of a proof of elapsed time algorithm in the distributive network of quantum annealers, quantum computers and other supercomputers. The validator nodes compute the problem sets and the one with the shortest elapsed time is the leader node which writes the transaction block to the ledger, and is used as most available resource and whose result may be chosen as leading computational result. All resource nodes have a copy of the same blockchain ledger. Repetitions in runs may be performed by each single node associated with an annealing time and so called temperature or may be performed singly across a network of cloned nodes, considered to be as part of a repetition of runs of a single computation. The equivalency to sharding and the implementation of sharding across databases on resource nodes or on other servers may apply in this case.

Therefore, blockchain is implemented in at least two instances, one is in choosing a leader among the node devices that require moving and/or driving along a trajectory, path. The other is in choosing the appropriate computer or platform applications and services to perform the computations at hand. A third is characterizing the network with etiquette and/or behavioral states while they are driven or moving as a network of devices.

Referring to the management of networked resources comprised of at least one of, a few of or all of the following: a quantum annealing computer, a quantum computer, a server, a supercomputer and any of their respective platform applications and/or services; the following describe illustrative embodiments and are in no way restrictive in their embodiment variations.

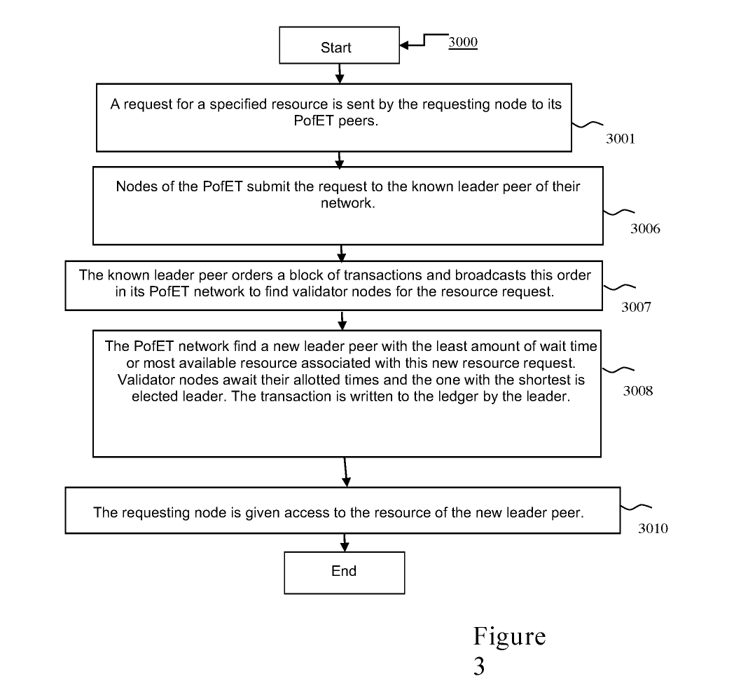

The first embodiment where only one consensus algorithm is used is shown in FIG. 3. The method begins with step 3001 where a request for a specified resource is sent by the requesting node to its PofET (Proof of Elapsed Time consensus algorithm) peers. Next, at step 3006, nodes of the PofET submit the request to the known (last) leader peer of their network. The third step 3007 is such that the known leader peer orders a block of transactions and broadcasts this order in its PofET network to find validator nodes for the resource request. The fourth step 3008 is where the PofET network finds validator nodes who then, according to the request, find a new leader peer with the least amount of wait time or most available resource(s) associated with this new resource request. After the leader is elected upon waiting the allotted transaction time, the transaction is written to the ledger. The method ends with step 3010 by having the requesting node be given access to the resource of the new leader peer, which preferably is the quantum annealer. The same method may be used to give access to other resources over the network.

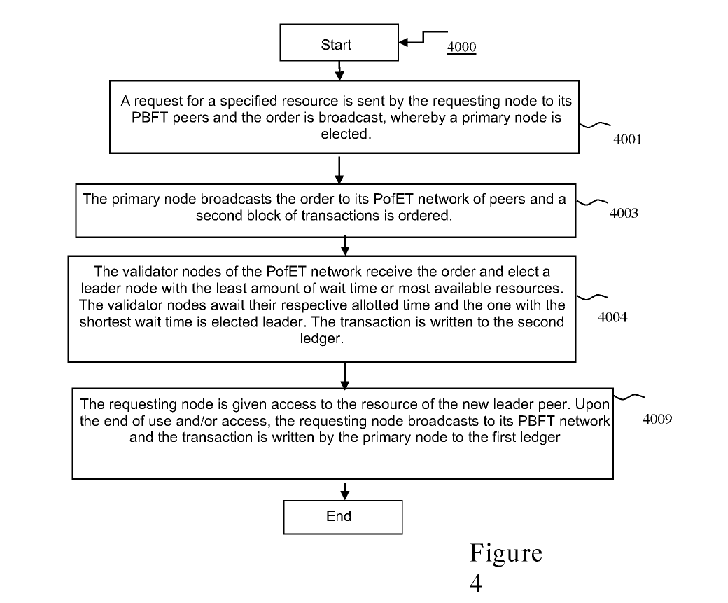

In the another embodiment, the method is as shown in FIG. 4. The method begins with the step 4001 of having a request for a specified resource sent by the requesting node to its PBFT (Practical Byzantine Fault Tolerance consensus algorithm) peers and an order for a block is broadcast, whereby a primary node is to be elected. The next step 4003 is such that the elected primary node, broadcasts this order to its PofET network of peers and a second block of transactions is ordered. The third step 4004 sees the validator nodes of the PofET network receive the order and elect a leader node with the least amount of wait time or the most available resources associated with the resource request. The validator nodes await their respective allotted time and the one with the shortest wait time is elected leader. The transaction is written to the second ledger. The fourth step 4009 is where the requesting node is given access to the resource(s) of the new leader peer. Upon the end of use and/or access, the requesting node broadcasts to its PBFT network and the transaction is written by the primary node to the first ledger. This may be the former primary node or a newly elected primary node to be consistent with immutable blockchain operational requirements. The method ends.

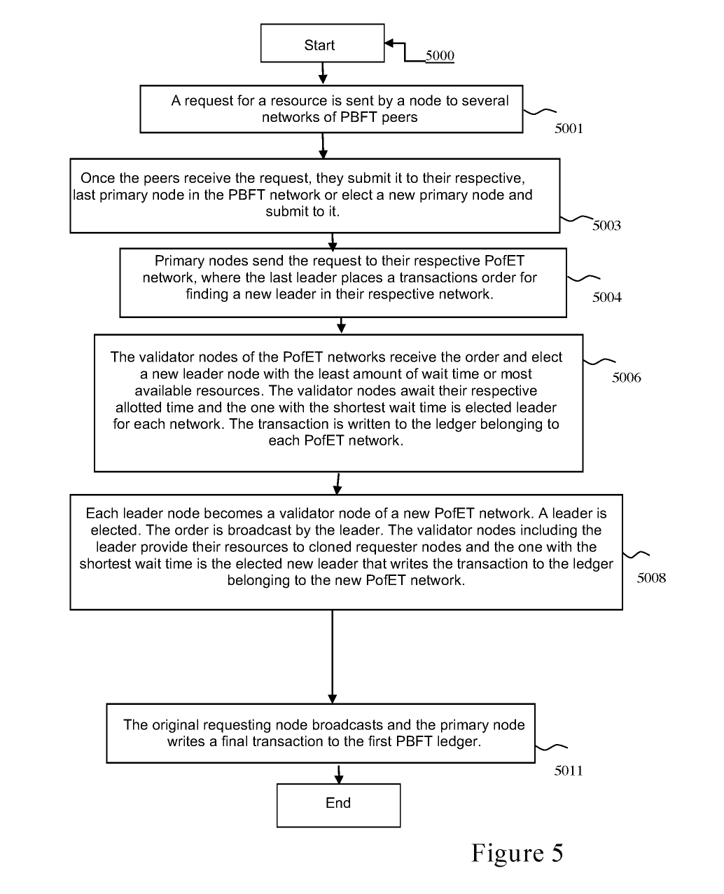

In another embodiment shown in FIG. 5, the method begins with the step 5001 of having a request for a resource sent by a node to several networks of PBFT peers. Once the peers receive the request, the step 5003 is such that they submit it to their respective, last primary node in their PBFT network or elect a new primary node in their PBFT network and submit to it. The third step 5004 sees the primary nodes send the request to their respective PofET network, where the last leader places a transaction order for finding a new leader in their respective network. The fourth step 5006 is such that the validator nodes of the PofET networks receive the order and proceed to elect a new leader node with the least amount of wait time or the most available resources. The validator nodes await their respective allotted time and the one with the shortest wait time is elected leader for each network. The transaction is written by the leader to the ledger belonging to each PofET network. The fifth step 5008 is such that each leader node becomes a validator node of a new PofET network. A leader is elected. In one embodiment, a threshold check or random sweep may be applied to reduce the number of leader nodes to be assigned to this one request, in which case the rejected resources may immediately be applied to other requests. Returning to the former embodiment, the order is rebroadcast and a final leader node with the least amount of wait time or most available resources (this time while handling the request, in other words the wait times are calculated while the resources are being used according to the original request) among these is elected to write to the ledger. These validator nodes, which have been chosen by the first PofET networks, provide their resources to cloned instances of the requesting node, the one with the shortest wait time is the final elected leader. Results from cloned instances of the requesting node with each validator node is in this case considered as repetitions of the original requested computation. The transaction is written by the final leader to the ledger belonging to the second PofET network. Finally, at the sixth step 5011, the original requesting node, upon ending, broadcasts in its PBFT and the primary node (former or newly elected) writes a final transaction to the first PBFT ledger. In this embodiment, a large amount of cloned computations may remove the need to perform repetitions in runs that are typical in a single quantum annealer. In this case, the computation performed according to the node request is introduced into the blockchain logic and the node with the shortest computational wait time is considered the leader that writes to the ledger. Cloning of the requesting node for the sake of executing upon this embodiment in terms of having say 3, 100, 1000 leader nodes at step 5008 applies. In this case, it is possible for such cloned and repeated computations to be considered as valid quantum annealer repetitions of a particular single computational request. Repetition in computational runs of quantum annealers are therefore performed according to the distributive network of blockchained nodes. As previously mentioned database sharding may be applied.

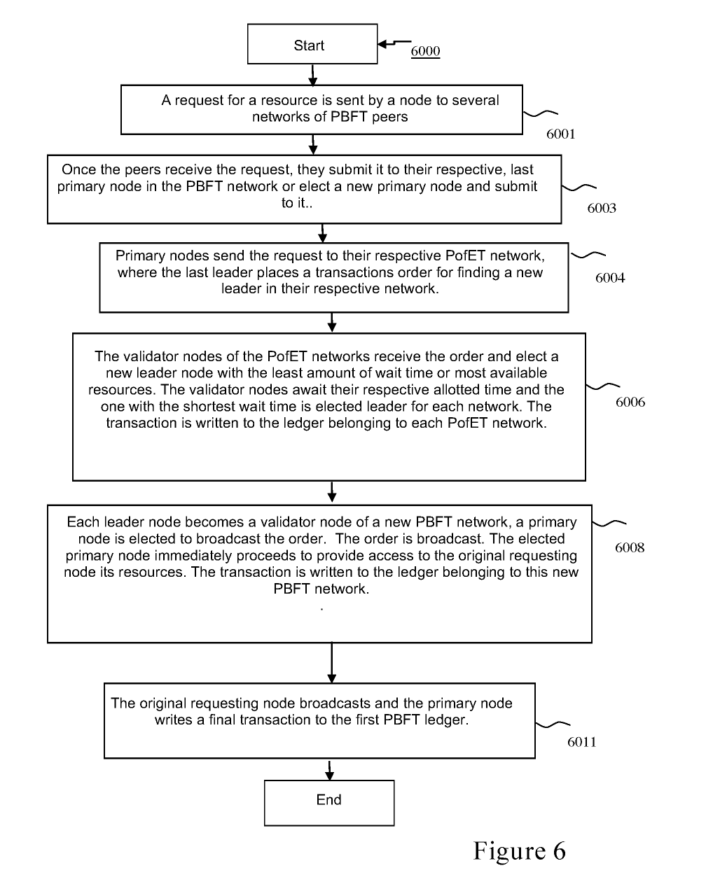

In another embodiment shown in FIG. 6, alternatively, access to the at least one quantum annealer resource is given after a leader has been chosen. The method begins with the step 6001 of having a request for a resource sent by a node to several networks of PBFT peers. Once the peers receive the request, the step 6003 is such that they submit it to their respective, last primary node in their PBFT network or elect a new primary node in their PBFT network and submit to it. The third step 6004 sees the primary nodes send the request to their respective PofET network, where the last leader places a transaction order for finding a new leader in their respective network. The fourth step 6006 is such that the validator nodes of the PofET networks receive the order and proceed to elect a new leader node with the least amount of wait time or the most available resources. The validator nodes await their respective allotted time and the one with the shortest wait time is elected leader for each network. The transaction is written by the leader to the ledger belonging to each PofET network. The fifth step 6008 is such that each leader node becomes a node of a new PBFT network and the order is rebroadcast and a final leader node (primary node) elected as one of the nodes with the least amount of wait time or most available resources. The elected final leader immediately proceeds to provide access to the original requesting node its quantum annealer resources for the allotted time, for a number of inputs, computational repetitions, at a repetition rate, etc. Upon end of access and/or use in the allotted time, the transaction is written by the leader to the ledger belonging to the new PBFT network. Finally, at the seventh step 6011, the original requesting node broadcasts to the first PBFT network and the primary node (former or newly elected) writes a final transaction to the first PBFT ledger.

As mentioned, checks may deviate the system from blockchain's operational requirements on immutability, but may however be useful when only 100 results are required and 1000 validator nodes are found. Furthermore, checks in between two consensus-based algorithmic steps, such as between 5006 and 5008, may increase robustness in the networked system by preliminarily removing some redundancy. By implementing at least two consensus networks one after the other, the system may immediately provide the resources to the requesting node by integrating said resource usage into the blockchain network as part of the implementation of the second consensus algorithm. It is also possible to distribute sets of nodes to provide resources to a cloned node (for example, 900 of the 1000 validator nodes to one cloned node vs 900 repetitions of the same computation on a single node or sharing 400 and 500 validator nodes to two cloned nodes each). In one embodiment, a threshold check or random sweep may be applied to reduce the number of leader nodes after step 6006 to be assigned to this one request, in which case the rejected resources may immediately be applied to other requests.

The preferred embodiment is such that each transaction, vote and/or election, step and/or aspect of the request for a quantum annealer resource is entirely managed by chaincode based on blockchain logic.

In another embodiment, the PBFT network instead of the PofET network is required at the fifth step 5006 and 5008 to place an order to elect the second leader (as a primary node), before access and/or use to the resource is provided.

In one embodiment, the associated resources to be accessed and/or used are introduced into the enclave area (known as a protected area of execution) for access and/or use until the associated resources have been accessed and/or used.

In one embodiment, shorter wait times may be calculated as representative of the real time and real resources being requested when simply voting for or electing a peer as in the case at step 6003 in FIG. 6. Speculative wait times may also be implemented when urgency arises.

A node may be another device, a service, a platform, a network provider, a server, a supercomputer, another quantum annealer, a quantum computer that may require at least once in time, at least one quantum annealer resource such as annealing time, number of inputs per computation, number of repetition, repetition rate and quantum annealer “temperature”, weighting or coupling values to inputs or any associated, related time-based resource such as size of input, size of demand for resources, priority status, probabilistic thresholds, naturalistic threshold or a threshold defined by analysis, data information or training results (such as from neural network training), other natural rates, timings, synchronicities, schedule related data resulting from neural network training or data information about natural processes, resource limits, communication times, limits, deviations, standards, protocols, etiquette rules etc. Enclaves may also be areas where the data from any of the above associated resources are stored, accessed from, removed from to be used by a process or thread. Any of the above quantum annealer resources may be introduced into the state space of a resource node.

In another embodiment, a node may be assigned more than one role at a given time.

The validator and/or primary nodes across the distributive networks, if having been offline for a time, or if suddenly engaged in a distributive network, may synchronize ledgers or request an updated copy of their respective distributive ledger and begin participation in a distributive network.

In one embodiment, a wait time that is calculated by another validator node, that has not been tabulated by the distributive ledger, such as a wait time not associated with the leader node, may be shared across the distributive network.

In the preferred embodiment, a separate ledger or a schedule, based on the original distributed ledger may list the leader and/or primary nodes in sequential order, along with the processes that were requested, listing the distributed resources available to the network of computing resources that require at least one time-based resource such as a quantum annealer. The list of these processes and process groups on the ledger may be pipelined, be removed from a pipeline, arbitrated by a priority request, an error or input/output quantum annealer request, notifications, handlers, signals whether synchronous or asynchronous, in real time or not. In other words, the pipelining events are mutable in that they may be cancelled, added, changed, though they generally follow the original distributive ledger outcomes. The original distributive ledgers however are, as according to blockchain technology, immutable and with time increasingly trust-worthy. Priorities based on these may arbitrate leader nodes that are already part of the original ledger.

In other embodiments, other consensus algorithms to elect a leader or primary or other role node may be implemented. For example, RAFT may be used to elect a leader to monitor or block a network of cloned nodes that are in the process of computing and addressing a node request, in that while computations are being performed, the leader sends heartbeat messages to all other nodes to establish that computation is being performed and no elections should occur until the leader stops sending hearbeat messages and writes to a ledger. This allows the monitoring process to also be introduced as part of blockchain logic. This embodiment may be implemented in addition to enclave protection.

Referring to the management of networked device nodes comprised of at least one autonomously moveable or driveable device; the following describes illustrative embodiments and are in no way restrictive in their embodiment variations.

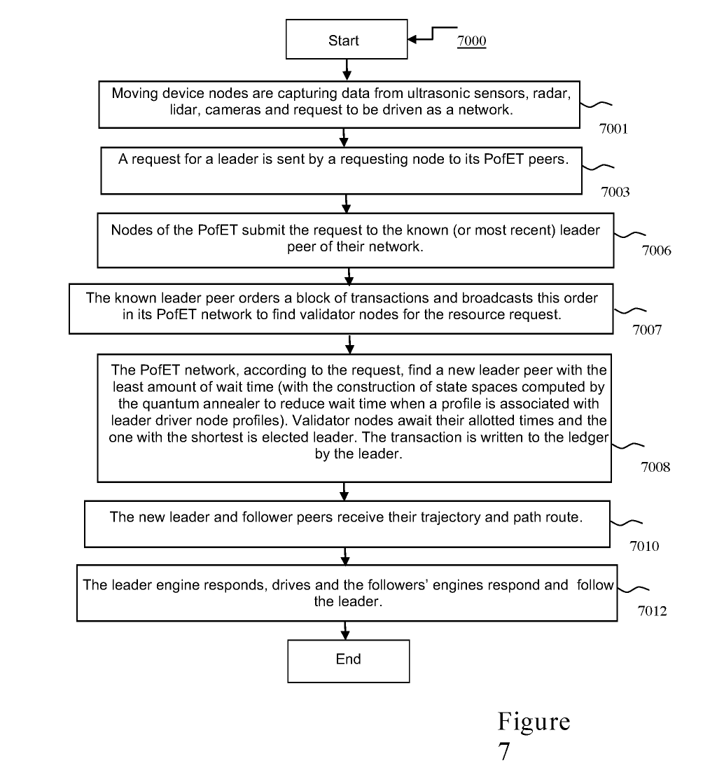

The first embodiment of finding a leader device, where only one consensus algorithm is used is shown in FIG. 7. The method starts at 7000 and begins with step 7001 where moving device nodes are capturing data from ultrasonic sensors, radar, lidar, cameras and request to be driven as a network of devices. A request for a leader is sent by a requesting node to its PofET peers at step 7003. Nodes of the PofET submit the request to the known or most recent leader peer of their network at step 7006, The known leader peer orders a block of transactions and broadcasts this order in its PofET network to find validator nodes for the resource request at step 7007. Next, at step 7008, the PofET network, according to the request, find a new leader peer with the least amount of wait time (with the construction of state spaces computed by the quantum annealer to reduce wait time when a profile is associated with leader driver node profiles). Validator nodes await their allotted times and the one with the shortest is elected leader. The transaction is written to the ledger by the leader. At step 7010, the new leader and follower peers receive their trajectory and path route. Finally, at step 7012, the leader engine responds, drives and the followers' engines respond and follower the leader.

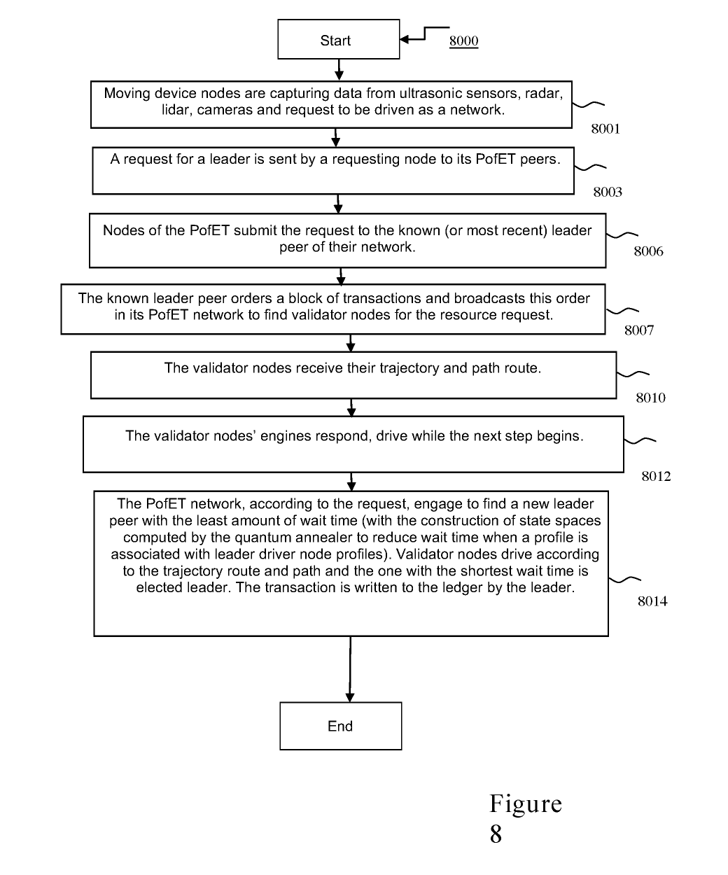

The second embodiment, where only one consensus algorithm is used and further where the determination of a leader is defined by the fastest device node to complete the trajectory and path route as part of the ledger network is shown in FIG. 8. The method starts at 8000 and begins with step 8001 where moving device nodes are capturing data from sensors, radar, lidar, cameras and request to be driven as a network. At step 8003, a request for a leader is sent by a requesting node to its PofET peers. At step 8006, the nodes of the PofET submit the request to the known or most recent leader peer of their network. At step 8007, the known leader peer orders a block of transactions and broadcasts this order in its PofET network to find validator nodes for the resource request. At step 8010, the validator nodes receive their trajectory and path route. At step 9012, the validator nodes' engines respond, drive while the next step begins. At step 8014, the PofET network, according to the request, engage to find a new leader peer with the least amount of wait time, with the construction of state spaces computed by the quantum annealer to reduce wait time when a profile is associated with leader driver node profiles. Validator nodes drive according to the trajectory route and path and the one with the shortest wait time is elected leader. The transaction is written to the ledger by the leader. The method ends.

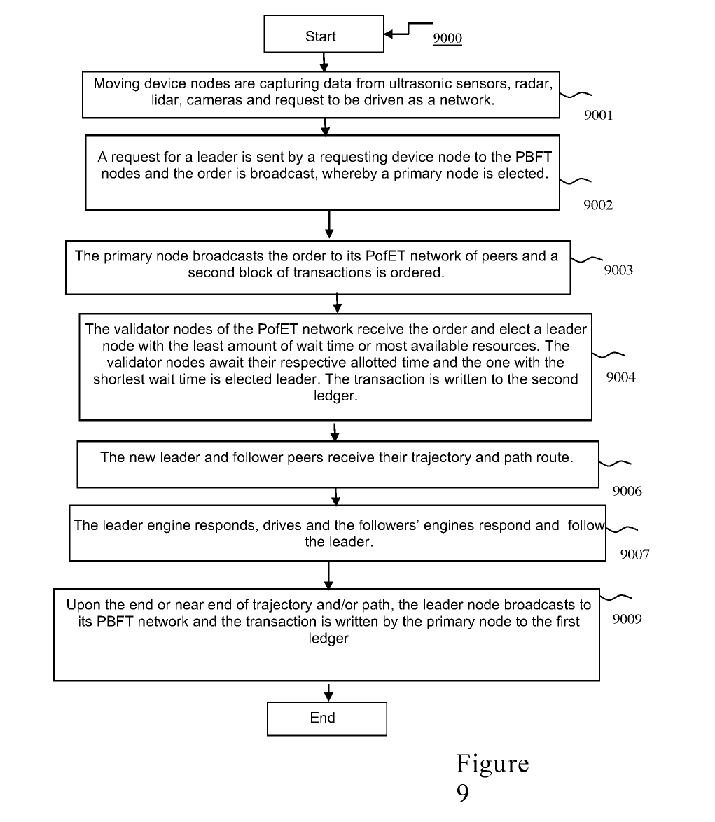

The third embodiment, where two consensus algorithms are used is shown in FIG. 9. The method starts at 9000 where step 9001 begins with moving device nodes capturing data from ultrasonic sensors, radar, lidar, cameras and request to be driven as a network. At step 9002, a request for a leader is sent by a requesting device node to the PBFT nodes and the order is broadcast, whereby a primary node is elected. At step 9003, the primary node broadcasts the order to its PofET network of peers and a second block of transactions is ordered. At step 9004, the validator nodes of the PofET network receive the order and elect a leader node with the least amount of wait time or most available resources. The validator nodes await their respective allotted time and the one with the shortest wait time is elected leader. The transaction is written to the second ledger. At step 9006, the new leader and follower peers receive their trajectory and path routes. At step 9007, the leader engine responds, drives and the followers' engines respond and follower the leader. At step 9009, upon the end or near end of the trajectory and/or path, the leader node broadcasts to its PBFT network and the transaction is written by the primary node to the first ledger. The method ends.

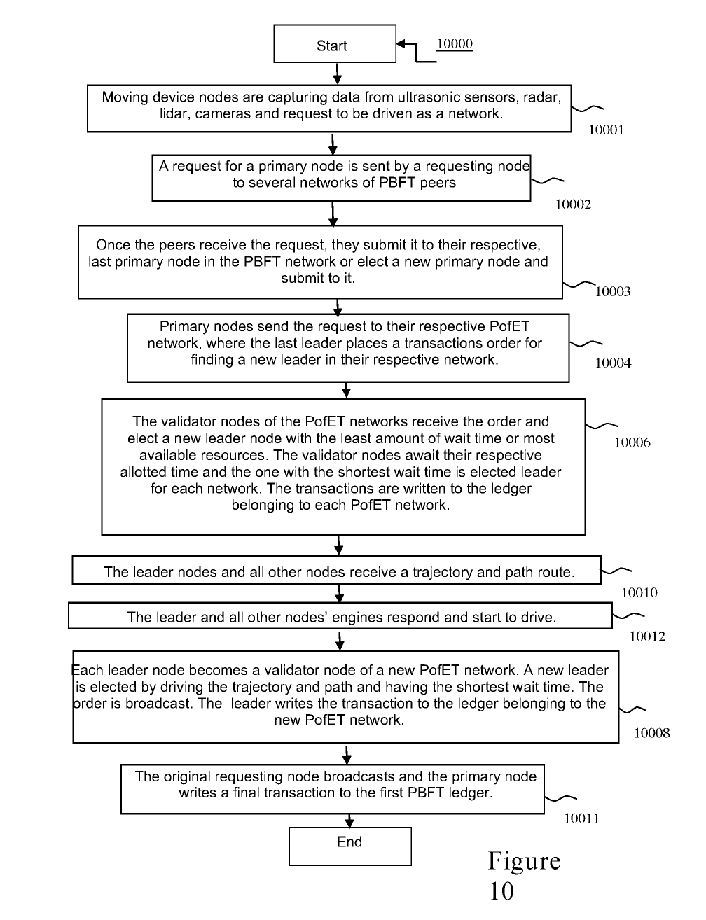

The fourth embodiment, where two consensus algorithms are used and where the leader is determined by the fastest device that completes a trajectory and/or path is shown in FIG. 10. The method starts at 10000 with step 10001 where moving device nodes are capturing data from sensors, radar, lidar, cameras and request to be driven as a network. At step 10002, a request for a primary node is sent by a requesting node to several networks of PBFT peers. At step 10003, once the peers receive the request, they submit it to their respective, last primary node in thire PBFT network or elect a new primary node and submit to it. At step 10004, primary nodes send the request to their respective PofET network, where the last leader places a transactions order for finding a new leader in their respective network. At step 10006, the validator nodes of the PofET networks receive the order and elect a new leader node with the least amount of wait time or most available resources. The validator nodes await their respective allotted time and the one with the shortest wait time is elected leader for each network. The transactions are written to the ledger belonging to each PofET network. At step 10010, the leader nodes and all other nodes receive a trajectory and path route. At step 10012, the leader and all other nodes' engines respond and start to drive. At step 10008, each leader node becomes a validator node of a new PofET network. A new leader is elected by driving the trajectory and path and having the shortest wait time. The order is broadcast. The leader writes the transaction to the ledger belonging to the new PofET network. At step 10011, the original requesting node broadcasts and the primary node writes a final transaction to the first PBFT ledger. The method ends.

Referring to FIG. 11, shown are several vehicles along a road 360 and an intersection 361, where two vehicles 375 and 77 are traveling in one direction next to each other. The space as a diameter around them, according to their center are drawn as circles ‘m’ and ‘o’ respectively. The section where their diameter circles overlap is denoted as the area ‘n’ 359. As described earlier, the vehicles travel along the road and vehicle 363 wants to join the network. Vehicle 363 then communicates with the other vehicle nodes in the network on the path between the points ‘x’ and ‘y’. The network broadcasts the request and the leader in this path is determined as being vehicle node 362, who has the shortest wait time to point ‘y’. Vehicle node 363 enters the network as a device follower to vehicle leader 362. Alternatively, the network of nodes between ‘x’ and ‘x’ choose a new leader, for example, a vehicle that is about to pass vehicle node 362. A new trajectory is set and the new leader takes that trajectory with all followers, including the new follower vehicle node 363, following behind. The path may be set between points ‘a’ and ‘b’ for the newly elected leader whereas the path of the new follower may be set between points ‘x’ and ‘y’. The vehicle nodes 375 and 377 have a spatial range between them delimited by area ‘n’ where collision is possible. As long as the autonomous vehicles avoid widening the area n to overlap the side of their vehicles in the limit, vehicle nodes 375 and 377 may travel and behave in any which way that does not conflict with the trajectory or path set for them, for example between the points ‘w’ 356 and ‘z’ 357.

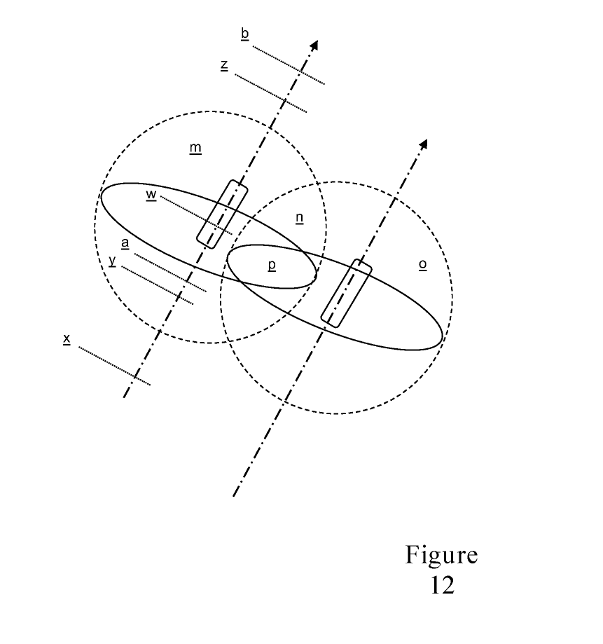

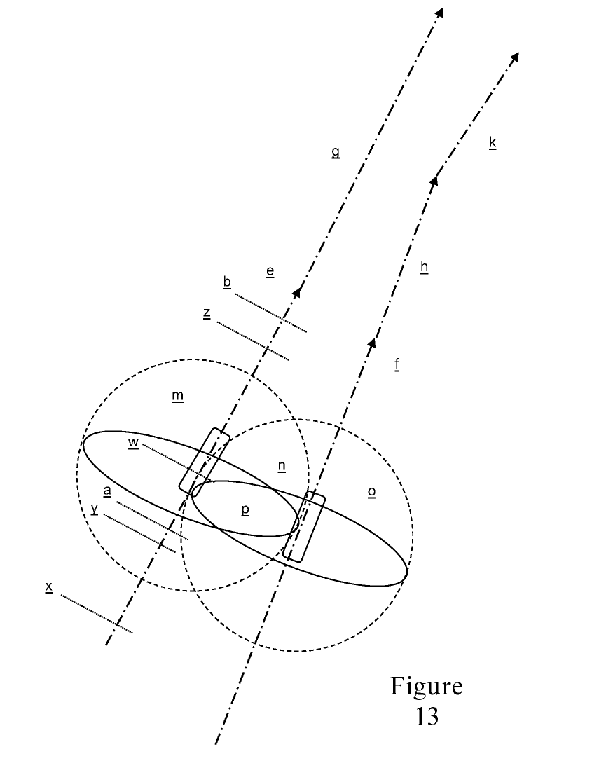

Alternatively, the same may be said for two vehicle nodes in a three dimensional space of movement and driving, as is shown in FIG. 12. Vehicles 460 and 462 are driven in three dimensional space and the volume for which their spatial spheres intersect is delimited by volume ‘n’ 459 and by area p 661. As long as the autonomous vehicles avoid widening the area ‘p’ or volume ‘n’ to overlap onto at least one side of their vehicles in the limit, vehicle nodes 460 and 462 may travel and behave in any which way that does not conflict with the trajectory or path set for them, for example between points ‘w’ and ‘z’ or ‘a’ and ‘b’. An example in which two nodes 460 and 462 are on a collision coarse is shown in FIG. 13. The vehicle nodes will be traveling along paths ‘e’ to ‘g’ for vehicle node 460 and paths ‘f’ to ‘h for vehicle 462. To avoid collision, vehicles 460 and 462 may detect that their spatial spheres ‘n’ and area ‘p’ have crossed a threshold value and therefore vehicle 462 requires reorientation of path optimization. Therefore path optimization though may have been pre-calculated according to a planned trajectory or path determined by at least one quantum annealer for example, but may be improved by reorientation according to the visual representation software implemented in the two vehicle nodes 460a nd 462. Alternatively, state spaces may be constructed in order to avoid collision in constructing the trajectories and paths.

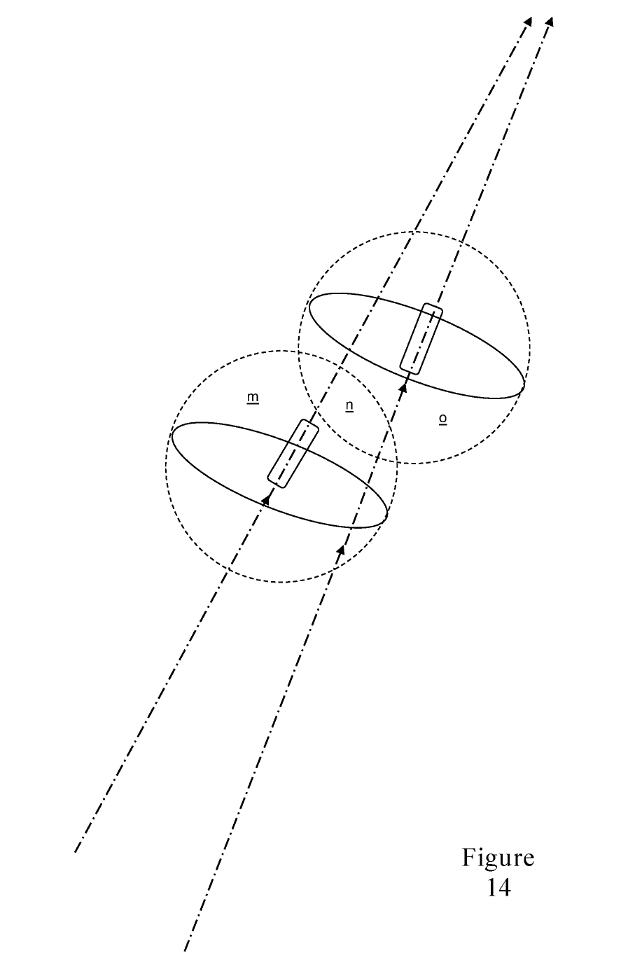

Referring to FIG. 14, vehicle nodes 460 and 462 may be the same as those referred to in FIGS. 12 and 13, on a path for possible collision. In this case, vehicle 462 is to surpass vehicle 460 and therefore in one case, vehicle 460 may be elected as the leader (being the one at higher speed and closer to a point on the forward path after a certain amount of time). As a leader, to avoid collision, the vehicle node is to decelerate and allow vehicle node 462 to continue its trajectory and or path at constant speed, in which case vehicle node 462 may then be switched to be elected as leader in continuing the trajectory or path. In another example, vehicle node 462 is elected leader and since it is ahead and at a higher speed than vehicle node 460, vehicle node 460 will have to decelerate to follow behind vehicle node 42 immediately. FIG. 14 therefore shows how action and behavior of the system are dictated by who is elected leader and this, according to state spaces that may contain weighted and coupled variables that represent etiquette for different regions and their particular cultural rules.

The term “comprising” throughout this application does not in any way mean to be wholly restricted to the elements that follow the said term “comprising”.

Although the present invention has been described by way of particular embodiments and examples thereof, it should be noted that it will be apparent to persons skilled in the art that modifications may be applied to the present particular embodiments without departing from the scope of the present invention.

1) A method for providing a network of devices a way to move or drive in a network of moving or driving devices along at least one trajectory or path, where at least one device is assigned as a leader device and at least one other device is assigned as a follower device according to the resulting computations from at least one Blockchain consensus algorithm.

2) (canceled)

3) (canceled)

4) (canceled)

5) The method of claim 1 where the Blockchain consensus algorithm is Proof of Elapsed Time.

6) The method of claim 1 where the Blockchain consensus algorithm is Practical Byzantine Fault Tolerance.

7) The method of claim 1 where the Blockchain consensus algorithm is Proof of Work.

8) (canceled)

9) (canceled)

10) (canceled)

11) (canceled)

12) (canceled)

13) (canceled)

14) (canceled)

15) (canceled)

16) A system for providing devices with a way to move or drive among moving or driving devices, the system comprised of:
At least one connected network of:
At least one movable or driveable device, the device comprised of:
At least one application.
At least one operating system.
At least one integrated circuit board.
At least one sensor device.
At least one memory.
At least one moving or driving apparatus.
with:
At least one platform for communicating with a Blockchain consensus algorithm service.

17) (canceled)

18) (canceled)

19) (canceled)

20) (canceled)
